(19) United States
(12) Patent Application Publication
(10) Pub. No.: US 2026/0260138 A1
(43) Pub. Date: Sep. 3, 2026

(54) MACHINE LEARNING APPARATUS, MACHINE LEARNING METHOD, AND COMPUTER READABLE MEDIUM

(71) Applicant: Mitsubishi Electric Corporation, Tokyo (JP)

(72) Inventor: Tsunato NAKAI, Tokyo (JP)

(73) Assignee: Mitsubishi Electric Corporation, Tokyo (JP)

(21) Appl. No.: 19/653,596

(22) Filed: Apr. 21, 2026

Related U.S. Application Data
(63) Continuation of application No. PCT/JP2023/044448, filed on Dec. 12, 2023.

(51) Int. Cl. G06N 5/04

(52) U.S. Cl. CPC G06N 5/04

(57) ABSTRACT

An inference unit (113) executes inference on input data for each model parameter set using a machine learning model to which the model parameter set is set, and obtains output data indicating an inference result of the machine learning model when the model parameter set has been set. A comparison unit (114) compares features of the inference results between pieces of the output data and obtains a comparison result. An output unit (115) determines information related to information leakage among information included in the inference result indicated in any of the pieces of output data based on the comparison result, applies a modification to the information related to information leakage on the output data, and outputs the modified output data.

### CROSS REFERENCE TO RELATED APPLICATION

This application is a Continuation of PCT International Application No. PCT/JP2023/044448, filed on December 12, 2023, which is hereby expressly incorporated by reference into the present application.

### TECHNICAL FIELD

The present disclosure relates to a measure against information leakage on a machine learning model.

### BACKGROUND ART

Generative AI is expected to be used in various industrial sectors. AI is abbreviation for artificial intelligence.

In particular, a machine learning model in which the scale of model parameters is large, such as a large language model, is expected to be used.

Here, the large language model will be described as a representative of the machine learning model in which the scale of model parameters is large. Points to be described here are also common to machine learning models related to other tasks, such as an image generative model and the like.

In order to construct and learn the large language model from scratch, an enormous computational cost and a massive dataset are required.

Therefore, it is considered to perform additional learning (fine tuning) with new learning data to an existing learned large language model. The additional learning is considered to fulfil unique corporate knowledge and the like on a pre-learned large language model, for example.

When tuning (full fine tuning) all model parameters is performed on a large language model, the parameter scale of the large language model causes a computational cost to remain high.

Then, Parameter Efficient Fine-Tuning (PEFT) which is fine tuning whose parameter efficiency is high, has been attracting attention.

PEFT tunes only a small number of additional model parameters without updating most of the model parameters of the pre-learned model. Therefore, it is possible to greatly reduce the computational cost and storage.

PEFT substitutes a small number of tuned parameter parts without replacing the whole model. Thereby, it is also possible to use a single pre-learned model to execute a plurality of tasks.

The model structure of the large language model is enormous. In other words, the large language model has a vast number of model parameters.

Therefore, it has been pointed out that the large language model tends to store learning data within the model. Further, it has been pointed out that the model is vulnerable to leaks of privacy information related to learning data from the model. Additionally, it has been pointed out that the model is vulnerable to leaks of sensitive information.

Patent Literature 1 discloses a configuration of a system that evaluates leakage risks of information from a learning model.

A fine-tuned large language model also has this vulnerability.

### Citation List

### Patent Literature

Patent Literature 1: JP 2022-007311 A

### SUMMARY OF INVENTION

### Technical Problem

A fine-tuned machine learning model (large language model) has a problem such as information leakage.

The present disclosure aims to reduce information leakage from the machine learning model.

### SOLUTION TO PROBLEM

A machine learning apparatus according to the present disclosure includes:

an inference unit to execute inference on input data for each model parameter set included in a plurality of model parameter sets that differ from each other, using a machine learning model to which the model parameter set is set, and to obtain output data indicating an inference result of the machine learning model when the model parameter set has been set;

a comparison unit to compare features of the inference results between a plurality of pieces of the output data corresponding to the plurality of model parameter sets, and to obtain a comparison result; and

an output unit to determine information related to information leakage among information included in the inference result indicated in any of the output data based on the comparison result, to apply a modification to the information related to information leakage on the output data, and to output the modified output data.

### Advantageous Effects of Invention

According to the present disclosure, it is possible to reduce information leakage from a machine learning model.

### BRIEF DESCRIPTION OF DRAWINGS

FIG. 1 is a diagram of a configuration of a machine learning apparatus 100 in Embodiment 1.

FIG. 2 is a flowchart of a machine learning method in Embodiment 1.

FIG. 3 is a flowchart of an example of implementation in Embodiment 1.

FIG. 4 is a diagram of the configuration of the machine learning apparatus 100 in Embodiment 2.

FIG. 5 is a flowchart of the machine learning method in Embodiment 2.

FIG. 6 is a flowchart of an example of the implementation in Embodiment 2.

FIG. 7 is a diagram of a hardware configuration of the machine learning apparatus 100 in the embodiments.

### DESCRIPTION OF EMBODIMENTS

In the Embodiments and drawings, the same elements or corresponding elements are denoted by the same reference sign. Description of an element denoted by the same reference sign as that of an element that has been described will be suitably omitted or simplified. Arrows in diagrams mainly indicate flows of data or flows of processing.

### Embodiment 1.

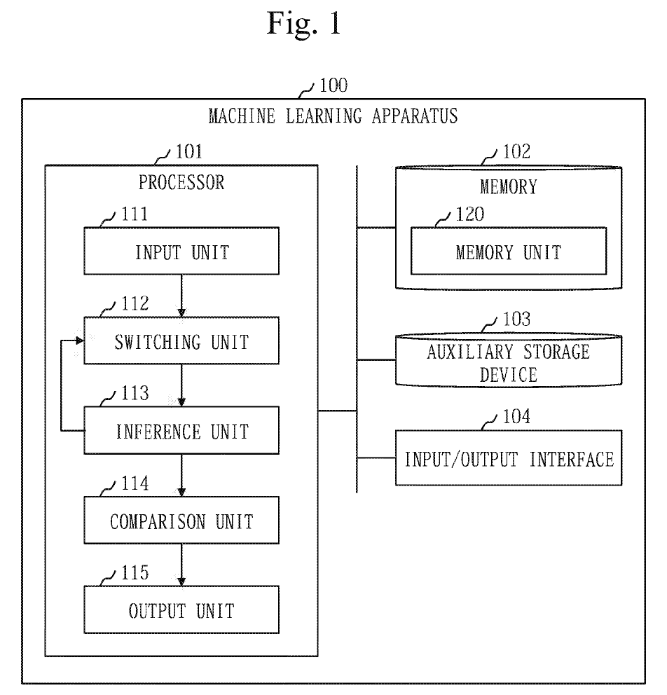

A measure against information leakage on a machine learning model will be described based on FIGS. 1 to 3.

### Description of Configuration

A configuration of a machine learning apparatus 100 will be described based on FIG. 1.

The machine learning apparatus 100 is a computer that includes pieces of hardware such as a processor 101, a memory 102, an auxiliary storage device 103, and an input/output interface 104. These pieces of hardware are connected with one another through signal lines.

The processor 101 is an IC that performs arithmetic processing, and controls other pieces of hardware. The processor 101 is, for example, a CPU, a DSP, or a GPU.

IC is abbreviation for Integrated Circuit.

CPU is abbreviation for Central Processing Unit.

DSP is abbreviation for Digital Signal Processor.

GPU is abbreviation for Graphics Processing Unit.

The memory 102 is a volatile or non-volatile storage device. The memory 102 is also referred to as a main memory unit or a main memory. The memory 102 is, for example, an RAM. Data stored in the memory 102 is saved in the auxiliary storage device 103 as necessary.

RAM is an abbreviation for Random Access Memory.

The auxiliary storage device 103 is a non-volatile storage device. The auxiliary storage device 103 is, for example, an ROM, an HDD, a flash memory, or a combination of these. Data stored in the auxiliary storage device 103 is loaded into the memory 102 as necessary.

ROM is an abbreviation for Read Only Memory.

HDD is an abbreviation for Hard Disk Drive.

The input/output interface 104 is a port to which input devices and output devices are connected. The input/output interface 104 is, for example, a USB terminal, the input devices are, for example, a keyboard, a mouse, and a communication device (receiver), and the output devices are, for example, a display and a communication device (transmitter). Input and output of the machine learning apparatus 100 is performed using the input/output interface 104.

USB is an abbreviation for Universal Serial Bus.

The machine learning apparatus 100 includes elements such as an input unit 111, a switching unit 112, an inference unit 113, a comparison unit 114, and an output unit 115. These elements are implemented by software.

The auxiliary storage device 103 stores a machine learning program for causing a computer to function as the input unit 111, the switching unit 112, the inference unit 113, the comparison unit 114, and the output unit 115. The machine learning program is loaded into the memory 102 and executed by the processor 101.

The auxiliary storage device 103 additionally stores an OS. At least a part of the OS is loaded into the memory 102 and executed by the processor 101.

While executing the OS, the processor 101 executes the machine learning program.

OS is an abbreviation for Operating System.

Input/output data of the machine learning program is stored in a storage unit 120.

The memory 102 functions as the storage unit 120. However, storage devices such as the auxiliary storage device 103, a register in the processor 101, and a cache memory in the processor 101 may also function as the storage unit 120 instead of the memory 102 or together with the memory 102.

The machine learning program can be recorded (stored) on a non-volatile recording medium such as an optical disc or a flash memory, in a computer readable format.

### Description of Operation

A procedure for operation of the machine learning apparatus 100 is equivalent to a machine learning method. Further, the procedure for the operation of the machine learning apparatus 100 is equivalent to a procedure for processing by the machine learning program.

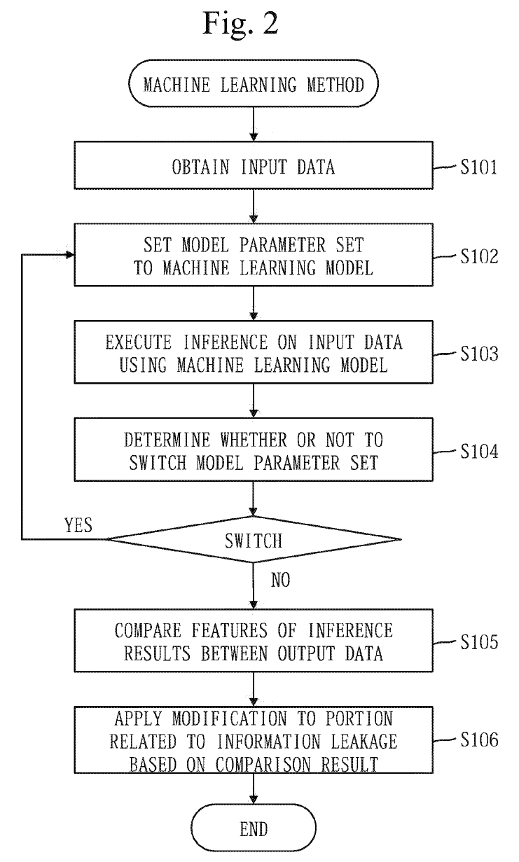

The machine learning method will be described based on FIG. 2.

In step S101, the input unit 111 obtains input data.

The input data is data that serves as input for the machine learning model. The input data is stored in a storage unit 190 in advance, for example.

The machine learning model (learned model) is a model generated by machine learning. The machine learning model is stored in the storage unit 190 in advance.

An example of the machine learning model is a large language model. When the machine learning model is the large language model, text data is the input data.

Steps S102 to S104 are repeatedly executed.

Steps S102 to S104 are executed by the switching unit 112 and the inference unit 113.

The switching unit 112 switches a model parameter set to be set to the machine learning model using a plurality of model parameter sets.

The model parameter set is one or more parameters (model parameters) used in the machine learning model.

The switching unit 112 generates a new model parameter set by adding a new model parameter to a current model parameter set of the machine learning model, for example. Then, the switching unit 112 uses the current model parameter set and the new model parameter set as the plurality of parameter sets.

The switching unit 112 generates a new model parameter set for each new model parameter included in two or more new model parameters by adding the new model parameter to a current model parameter set of the machine learning model, for example. Then, the switching unit 112 uses two or more new model parameter sets corresponding to the two or more new model parameters as the plurality of parameter sets.

The inference unit 113 executes inference on the input data for each model parameter set using the machine learning model to which the model parameter set is set. As a result, output data is obtained. The output data indicates an inference result of the machine learning model when the model parameter has been set.

Procedures for steps S102 to S104 will be described.

In step S102, the switching unit 112 sets the model parameter set to the machine learning model.

A part of the model parameter set differs for each execution of step S102.

In step S103, the inference unit 113 executes inference on the input data using the machine learning model. As a result, output data is obtained.

When the machine learning model is the large language model, text data is the output data. In this case, an output text (output data) indicates a token sequence corresponding to an input text (input data). The token sequence consists of one or more tokens. The tokens are equivalent to, for example, words.

In step S104, the switching unit 112 determines whether or not to switch the model parameter set to be set to the machine learning model.

When the number of times the model parameter set is switched has not reached a predetermined number of times, the switching unit 112 determines to switch the model parameter set, for example.

When the model parameter set to be set to the machine learning model is switched, the process proceeds to step S102.

When the model parameter set to be set to the machine learning model is not switched, the process proceeds to step S105.

From steps S102 to S104, a plurality of pieces of output data corresponding to the plurality of model parameter sets are obtained.

In step S105, the comparison unit 114 compares features of inference results between the plurality of pieces of output data. As a result, a comparison result is obtained.

An example of the features to be compared is probability transitions, probability distributions, or cosine similarity degrees of the inference results. These are features related to information leakage.

When the machine learning model is the large language model, for example, probability transitions between tokens in token sequences indicated in output texts are compared between the output texts. Then, an abnormal probability transition is detected. The abnormal probability transition is a state whose possibility of transition under normal operation is low, for example. It is possible to detect the abnormal probability transition by evaluating whether or not the magnitude (probability) of the possibility of transition is lower than a predetermined threshold value.

In step S106, the output unit 115 selects one piece of output data from the plurality of pieces of output data.

When the plurality of pieces of output data are two pieces of output data corresponding to a current model parameter set and a new model parameter set, the output unit 115 selects output data corresponding to the new model parameter set, for example.

Next, the output unit 115 determines information related to information leakage among information included in the inference result indicated by the selected output data, based on the comparison result.

The output unit 115 determines a portion in which the abnormal probability transition is detected in the token sequence indicated in the output text as the information related to information leakage, for example.

Next, the output unit 115 applies to the selected output data, a modification to the information related to information leakage.

The output unit 115 applies the modification to the output data in any of the following ways, for example.

The output unit 115 removes (deletes) the information related to information leakage.

The output unit 115 replaces the information related to information leakage with information whose feature is reduced.

The output unit 115 incorporates (adds) information related to information leakage of other output data into the information related to information leakage of the selected output data.

When the machine learning model is the large language model, for example, a token in a portion in which the abnormal probability transition has been detected is replaced with a similar token in which feature of the token is reduced. The token in the portion in which the abnormal probability transition has been detected is subtle information in additional learning (additional parameters). When the subtle information is an individual name, the subtle information is replaced with a similar token such as a fictitious name that is not a real name, for example. In such a manner, it is possible to exclude the feature of the subtle information from the output data. Therefore, it is possible to prevent information leakage from the machine learning model.

Then, the output unit 115 outputs the modified output data.

The output unit 115 stores the modified output data in the storage unit 190, for example.

### Description of Implementation Example

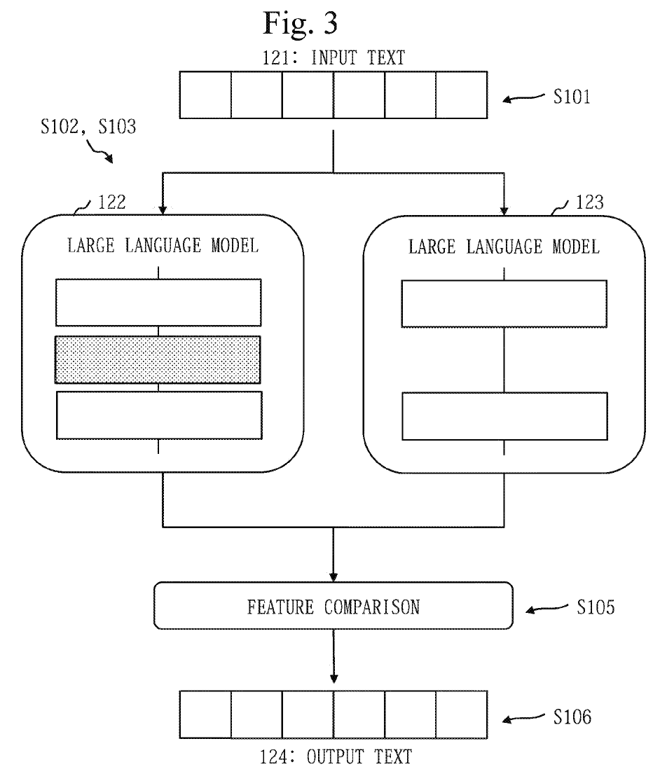

An example of a case in which features of output are compared in terms of the presence or absence of a PEFT parameter setting for the large language model will be described based on FIG. 3.

The large language model is a pre-learned machine learning model.

In PEFT, a parameter itself of the pre-learned machine learning model is not updated. Hence, model parameters of the large language model can be switched by adding or not adding a parameter.

In step S101, the input unit 111 obtains an input text 121.

In step S102, the switching unit 112 adds a PEFT parameter to the model parameter set, and sets the model parameter set to the large language model. The large language model with addition of the PEFT parameter is referred to as a large language model 122.

In step S103, the inference unit 113 executes inference on the input text 121 using the large language model 122. As a result, an output text is obtained.

In step S102, the switching unit 112 sets the model parameter set to the large language model without adding the PEFT parameter. The large language model without addition of the PEFT parameter is referred to as a large language model 123.

In step S103, the inference unit 113 executes inference on the input text 121 using the large language model 123. As a result, an output text is obtained.

In step S105, the comparison unit 114 compares prediction probabilities of word sequences (token sequences) between two output texts.

In step S106, when transitions of the prediction probabilities of the word sequences are different between the output texts, the output unit 115 replaces a target token of the output text of the large language model 122 with a similar token for reducing a difference in the transitions of the prediction probabilities. The output text of the large language model 122 after replacement is referred to as an output text 124. The output unit 115 outputs the output text 124.

### Effects of Embodiment 1

Embodiment 1 aims to easily apply a measure against information leakage on a fine-tuned machine learning model (large language model) to existing fine-tuning techniques without degrading model performance.

Embodiment 1 can implement the machine learning apparatus 100, the machine learning method, and the machine learning program that do not leak information related to learning data when certain input data is inferred.

Embodiment 1 compares output data during switching of an additional parameter for the fine-tuned (PEFT) machine learning model, and eliminates or reduces a feature related to information leakage. A main effect of Embodiment1 is to prevent information leakage from the machine learning model.

Embodiment 1 is configured by switching of an additional parameter and comparison of inference results. Therefore, Embodiment 1 can be introduced without manipulating model learning, and Embodiment 1 has less degradation of model performance compared to existing methods. Adding configurations of parameter switching and output comparison can easily be applied to the existing fine-tuning techniques.

### Embodiment 2.

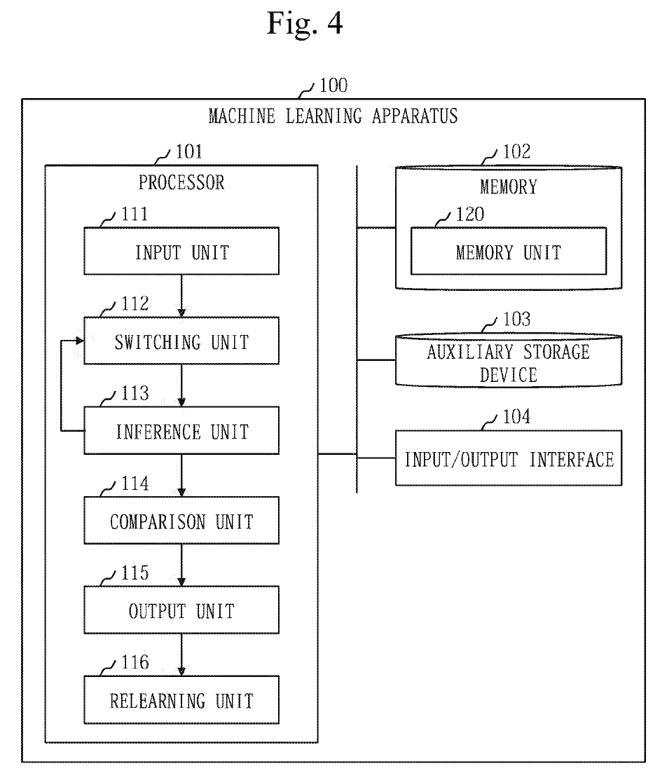

Regarding an embodiment in which the machine learning model is relearned using the output data obtained in Embodiment 1, differences from Embodiment 1 will mainly be described based on FIGS. 4 to 6.

### Description of Configuration

The configuration of the machine learning apparatus 100 will be described based on FIG. 4.

The machine learning apparatus 100 further includes a relearning unit 116.

The machine learning program further causes a computer to function as the relearning unit 116.

### Description of Operation

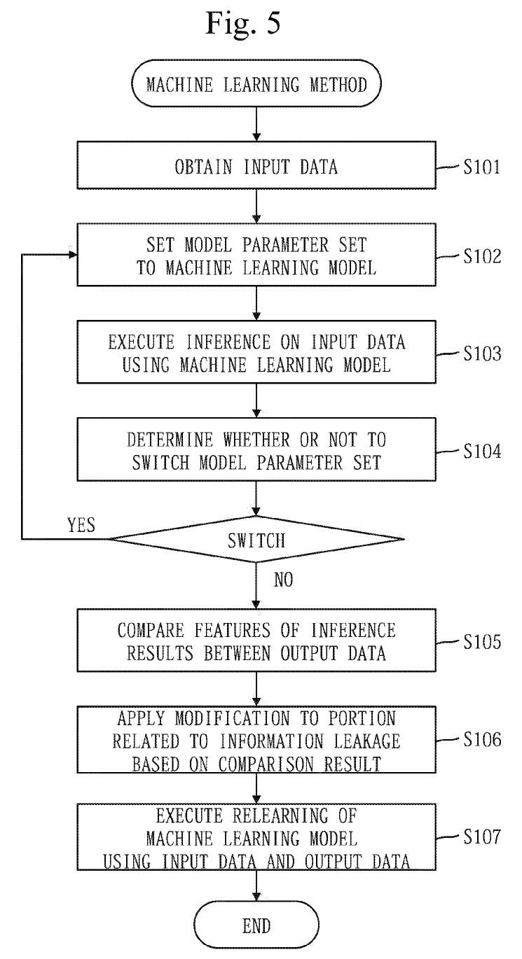

The machine learning method will be described based on FIG. 5.

Steps S101 to S106 are as described in Embodiment 1.

In step S107, the relearning unit 116 performs relearning of the machine learning model using the input data obtained in step S101 as learning data and using the modified output data obtained in step S106 as correct data.

The relearning unit 116 performs fine tuning to update an additional parameter (part of parameters in the machine learning model) using a learning dataset (learning data and correct data), for example.

### Description of Embodiment

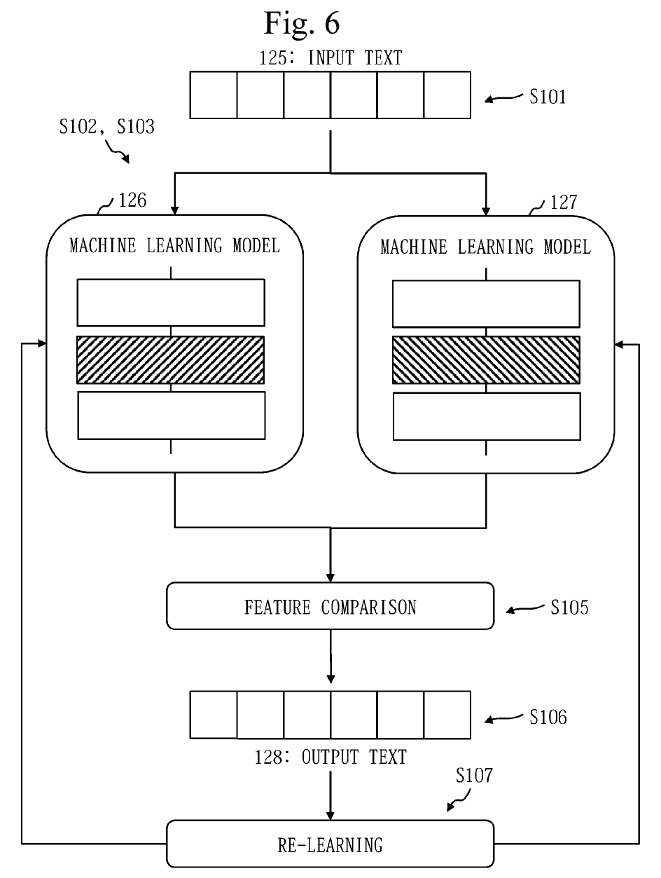

An example of a case in which features of output are compared under different PEFT parameter settings for the large language model will be described based on FIG. 6.

In step S101, the input unit 111 obtains an input text 125. The input text 125 is text data collected for training.

In step S102, the switching unit 112 adds a PEFT parameter (1) to the model parameter set, and sets the model parameter set to the large language model. The large language model to which the PEFT parameter (1) is added is referred to as a large language model 126.

In step S103, the inference unit 113 executes inference on the input text 125 using the large language model 126. As a result, an output text is obtained.

In step S102, the switching unit 112 adds a PEFT parameter (2) to the model parameter set, and sets the model parameter set to the large language model. The large language model to which the PEFT parameter (2) is added is referred to as a large language model 127.

In step S103, the inference unit 113 executes inference on the input text 125 using the large language model 127. As a result, an output text is obtained.

In step S105, the comparison unit 114 compares prediction probabilities of word sequences (token sequences) between two output texts.

In step S106, when transitions of prediction probabilities of the word sequences are different between the output texts, the output unit 115 modifies a target token of the output text of the large language model 126 or the large language model 127. The output unit 115 incorporates the target token of the output text of the large language model 127 into the target token of the output text of the large language model 126, for example. Otherwise, the output unit 115 replaces the target token of the output text of the large language model 126 with the target token of the output text of the large language model 127. The modified output text is referred to as an output text 128.

In step S107, the relearning unit 116 creates a learning dataset (learning data and correct data) using the input text 125 as the learning data and using the output text 128 as the correct data. Then, the relearning unit 116 performs relearning of the large language model by updating the PEFT parameter (1) and the PEFT parameter (2) using the learning dataset.

### Effects of Embodiment 2

Embodiment 2 aims to generate a machine learning model that provides highly accurate output data without any information leakage.

Embodiment 2 has a configuration of switching a plurality of additional parameters, and a configuration of relearning the machine learning model using output data whose features have been compared.

Embodiment 2 can implement the machine learning apparatus 100, the machine learning method, and the machine learning program that train the machine learning model that does not leak information related to learning data when certain input data is inferred.

Embodiment 2 compares output data during switching of an additional parameter for the fine-tuned (PEFT) machine learning model, and uses data whose feature related to information leakage has been eliminated, reduced or incorporated, as new correct data. A main effect of Embodiment 2 is to generate a machine learning model without any information leakage by relearning the fine-tuned (PEFT) machine learning models.

Embodiment 2 is configured by adding configurations of parameter switching and output comparison. Therefore, Embodiment 2 can be easily applied to existing fine-tuning techniques. Further, Embodiment 2 generates a machine learning model without any information leakage. Therefore, there is no need to implement an additional function for an information leakage measure when the machine learning model is applied to a product.

### Supplement to Embodiments

A type of machine learning operation is not limited to deep learning, and may also be operation such as regression analysis, decision tree learning, Bayes' theorem, or clustering.

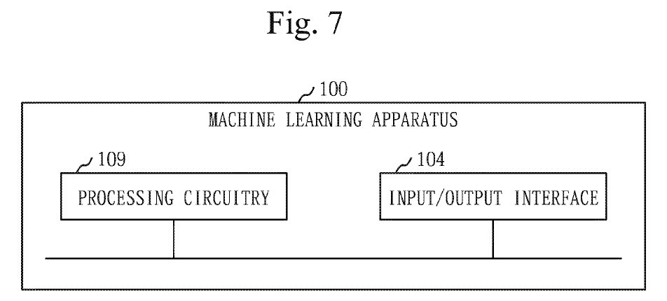

A hardware configuration of the machine learning apparatus 100 will be described based on FIG. 7.

The machine learning apparatus 100 includes processing circuitry 109.

The processing circuitry 109 is a piece of hardware that implements the input unit 111, the switching unit 112, the inference unit 113, the comparison unit 114, the output unit 115, and the relearning unit 116.

The processing circuitry 109 may be dedicated hardware, or may be the processor 101 that executes programs stored in the memory 102.

When the processing circuitry 109 is the dedicated hardware, the processing circuitry 109 is, for example, a single circuit, a compound circuit, a programmed processor, a parallel programmed processor, an ASIC, an FPGA, or a combination of these.

ASIC is an abbreviation for Application Specific Integrated Circuit.

FPGA is an abbreviation for Field Programmable Gate Array.

The machine learning apparatus 100 may include a plurality of pieces of processing circuitry as an alternative to the processing circuitry 109.

In the processing circuitry 109, some functions may be implemented by the dedicated hardware, while the remaining functions may be implemented by software or firmware.

In such a manner, a function of the machine learning apparatus 100 can be implemented by hardware, software, firmware, or a combination of these.

Each embodiment is an example of a preferable embodiment, and is not intended to limit the technical scope of the present disclosure. Each embodiment may be implemented partially, or may be implemented in combination with another embodiment. The procedures described using the flowcharts or the like may be suitably modified.

"Unit" of each element of the machine learning apparatus 100 may be interpreted as "process", "step", "circuit" or "circuitry".

### Reference Signs List

100: machine learning apparatus; 101: processor; 102: memory; 103: auxiliary storage device; 104: input/output interface; 109: processing circuitry; 111: input unit; 112: switching unit; 113: inference unit; 114: comparison unit; 115: output unit; 116: relearning unit; 121: input text; 122: large language model; 123: large language model; 124: output text; 125: input text; 126: large language model; 127: large language model; 128: output text; 190: storage unit.

1. A machine learning apparatus comprising: processing circuitry: to execute inference on input data for each model parameter set included in a plurality of model parameter sets that differ from each other, using a machine learning model to which the model parameter set is set, and to obtain output data indicating an inference result of the machine learning model when the model parameter set has been set; to compare features of the inference results between a plurality of pieces of the output data corresponding to the plurality of model parameter sets, and to obtain a comparison result; to determine information related to information leakage among information included in the inference result indicated in any of the output data based on the comparison result, to apply a modification to the information related to information leakage on the output data, and to output the modified output data; and to generate a new model parameter set by adding a new model parameter to a current model parameter set of the machine learning model, and to switch a model parameter set that is set to the machine learning model using the current model parameter set and the new model parameter set as the plurality of model parameter sets.

2. A machine learning apparatus comprising: processing circuitry: to execute inference on input data for each model parameter set included in a plurality of model parameter sets that differ from each other, using a machine learning model to which the model parameter set is set, and to obtain output data indicating an inference result of the machine learning model when the model parameter set has been set; to compare features of the inference results between a plurality of pieces of the output data corresponding to the plurality of model parameter sets, and to obtain a comparison result; to determine information related to information leakage among information included in the inference result indicated in any of the output data based on the comparison result, to apply a modification to the information related to information leakage on the output data, and to output the modified output data; and to generate a new model parameter set for each new model parameter included in two or more new model parameters by adding the new model parameter to a current model parameter set of the machine learning model, and to switch a model parameter set that is set to the machine learning model using two or more new model parameter sets corresponding to the two or more new model parameters as the plurality of model parameter sets.

3. A machine learning apparatus comprising: processing circuitry: to execute inference on input data for each model parameter set included in a plurality of model parameter sets that differ from each other, using a machine learning model to which the model parameter set is set, and to obtain output data indicating an inference result of the machine learning model when the model parameter set has been set; to compare features of the inference results between a plurality of pieces of the output data corresponding to the plurality of model parameter sets, and to obtain a comparison result; to determine information related to information leakage among information included in the inference result indicated in any of the output data based on the comparison result, to apply a modification to the information related to information leakage on the output data, and to output the modified output data; and to execute relearning of the machine learning model using the input data as learning data and the modified output data as correct data.

4. The machine learning apparatus according to claim 1, wherein the processing circuitry compares probability transitions of the inference results between output data, as the features.

5. The machine learning apparatus according to claim 1, wherein the processing circuitry compares probability distributions of the inference results between output data, as the features.

6. The machine learning apparatus according to claim 1, wherein the processing circuitry compares cosine similarity degrees of the inference results between the output data, as the features.

7. The machine learning apparatus according to claim 1, wherein the processing circuitry applies to the output data, either exclusion, reduction, or incorporation, as a modification on the information related to information leakage.

8. A machine learning method comprising: executing, inference on input data for each model parameter set included in a plurality of model parameter sets that differ from each other, using a machine learning model to which the model parameter set is set, and obtaining output data indicating an inference result of the machine learning model when the model parameter set has been set; comparing features of the inference results between a plurality of pieces of the output data corresponding to the plurality of model parameter sets, and obtaining a comparison result; determining information related to information leakage among information included in the inference result indicated in any of the output data based on the comparison result, applying a modification to the information related to information leakage on the output data, and outputting the modified output data; and generating a new model parameter set by adding a new model parameter to a current model parameter set of the machine learning model, and switching a model parameter set that is set to the machine learning model using the current model parameter set and the new model parameter set as the plurality of model parameter sets.

9. A machine learning method comprising: executing, inference on input data for each model parameter set included in a plurality of model parameter sets that differ from each other, using a machine learning model to which the model parameter set is set, and obtaining output data indicating an inference result of the machine learning model when the model parameter set has been set; comparing features of the inference results between a plurality of pieces of the output data corresponding to the plurality of model parameter sets, and obtaining a comparison result; determining information related to information leakage among information included in the inference result indicated in any of the output data based on the comparison result, applying a modification to the information related to information leakage on the output data, and outputting the modified output data; and generating a new model parameter set for each new model parameter included in two or more new model parameters by adding the new model parameter to a current model parameter set of the machine learning model, and switching a model parameter set that is set to the machine learning model using two or more new model parameter sets corresponding to the two or more new model parameters as the plurality of model parameter sets.

10. A machine learning method comprising: executing, inference on input data for each model parameter set included in a plurality of model parameter sets that differ from each other, using a machine learning model to which the model parameter set is set, and obtaining output data indicating an inference result of the machine learning model when the model parameter set has been set; comparing features of the inference results between a plurality of pieces of the output data corresponding to the plurality of model parameter sets, and obtaining a comparison result; determining information related to information leakage among information included in the inference result indicated in any of the output data based on the comparison result, applying a modification to the information related to information leakage on the output data, and outputting the modified output data; and executing relearning of the machine learning model using the input data as learning data and the modified output data as correct data.

11. A non-transitory computer readable medium storing a machine learning program for causing a computer to execute: an inference process to execute inference on input data for each model parameter set included in a plurality of model parameter sets that differ from each other, using a machine learning model to which the model parameter set is set, and to obtain output data indicating an inference result of the machine learning model when the model parameter set has been set; a comparison process to compare features of the inference results between a plurality of pieces of the output data corresponding to the plurality of model parameter sets, and to obtain a comparison result; an output process to determine information related to information leakage among information included in the inference result indicated in any of the output data based on the comparison result, to apply a modification to the information related to information leakage on the output data, and to output the modified output data; and a switching process to generate a new model parameter set by adding a new model parameter to a current model parameter set of the machine learning model, and to switch a model parameter set that is set to the machine learning model using the current model parameter set and the new model parameter set as the plurality of model parameter sets.

12. A non-transitory computer readable medium storing a machine learning program for causing a computer to execute: an inference process to execute inference on input data for each model parameter set included in a plurality of model parameter sets that differ from each other, using a machine learning model to which the model parameter set is set, and to obtain output data indicating an inference result of the machine learning model when the model parameter set has been set; a comparison process to compare features of the inference results between a plurality of pieces of the output data corresponding to the plurality of model parameter sets, and to obtain a comparison result; an output process to determine information related to information leakage among information included in the inference result indicated in any of the output data based on the comparison result, to apply a modification to the information related to information leakage on the output data, and to output the modified output data; and a switching process to generate a new model parameter set for each new model parameter included in two or more new model parameters by adding the new model parameter to a current model parameter set of the machine learning model, and to switch a model parameter set that is set to the machine learning model using two or more new model parameter sets corresponding to the two or more new model parameters as the plurality of model parameter sets.

13. A non-transitory computer readable medium storing a machine learning program for causing a computer to execute: an inference process to execute inference on input data for each model parameter set included in a plurality of model parameter sets that differ from each other, using a machine learning model to which the model parameter set is set, and to obtain output data indicating an inference result of the machine learning model when the model parameter set has been set; a comparison process to compare features of the inference results between a plurality of pieces of the output data corresponding to the plurality of model parameter sets, and to obtain a comparison result; an output process to determine information related to information leakage among information included in the inference result indicated in any of the output data based on the comparison result, to apply a modification to the information related to information leakage on the output data, and to output the modified output data; and a relearning process to execute relearning of the machine learning model using the input data as learning data and the modified output data as correct data.
